(19) United States
(12) Patent Application Publication
(10) Pub. No.: US 2002/0059171 A1
(43) Pub. Date: May 16, 2002

(54) Method and system for resource planning and management

(76) Inventor: Bredt Donald Martin, Valencia, CA (US)

Correspondence Address: Bredt D. Martin, Esq., 24821 Los Altos Drive, Valencia, CA, 91355, US

(21) Appl. No.: 09/836,401

(22) Filed: Apr. 17, 2001

Related U.S. Application Data
(60) Provisional application No. 60/198,588, filed on Apr. 18, 2000.

(51) Int. Cl. G06F 7/00

(52) U.S. Cl. 707/1

(57) ABSTRACT

A method and system for providing an integrated budgeting and performance measurement system and an improved planning, budgeting and financial management capability. Typical such methods and systems require centralized and/or multiple manual data entry of resource planning information. The method and system provides for one time manual input of resource planning information, and electronic transfer thereof to a cost management software program and an accounting software program. The method and system further permits data entry remote from a cost management software program and on a different computer operating system than that native to a cost management software program.

### CROSS-REFERENCE TO RELATED APPLICATIONS

This patent application claims the benefit of the filing date of U.S. Provisional Patent Application Serial No. 60/198,588, filed Apr. 18, 2000 and entitled “METHOD AND SYSTEM FOR RESOURCE PLANNING AND MANAGEMENT,” the entire contents of which are hereby expressly incorporated by reference.

### FIELD OF THE INVENTION

The present invention relates to methods and systems for resource planning and management, and, more particularly, to network integrated methods and systems for resource planning and management. The invention further relates to graphical user interfaces (GUIs) to cost management software programs, both of which are components of such network integrated systems.

### BACKGROUND OF THE INVENTION

Having an improved method and system for resource planning and management, which permits one-time manual entry of resource planning data from several different computer operating systems, and which permits one-time manual entry of data into a simplified graphical user interface (GUI) remote from a commercial, off the shelf (COTS), cost management software program, which data is then electronically transferred into the COTS cost management soilware program, is highly desirable.

This invention relates to a network integrated method and system for resource planning and management. It is in particular concerned with a network integrated method and system for use in conjunction with one or more COTS cost management software programs. More particularly, the invention relates to a network integrated method and system for resource planning data entry to a simplified graphical user interface (GUI) remote from a COTS cost management software program, which data is then electronically transferred into the COTS cost management software program.

One prior method and system for resource planning and management requires that resource planning data manual entry be performed multiple times by multiple individuals into multiple, non-integrated systems. Often, initial resource planning will be performed by an individual at his or her personal computer workstation utilizing a simplified spreadsheet or calculator to determine a rudimentary resource plan. When complete, the individual takes the resource plan to a financial planner who then re-keys the plan data into a COTS cost management software program. In some cases, the financial planner then re-keys the plan data into a COTS enterprise accounting software program. These prior methods require redundant manual entry of the same planning data, and have no assurance that the intention of the individual doing the initial planning is honored when the planning data reaches its ultimate residence.

Another of the prior techniques requires that the COTS cost management software program be utilized by the individual doing the initial resource planning. However, this technique requires that each individual doing resource planning learn a relatively sophisticated COTS cost management software program, have a computer operating system native to the COTS cost management software program, and incur the additional cost of purchasing a license for the COTS cost management software program.

Accordingly, there is a need in the industry for a network integrated method and system which permits individuals to enter resource planning data into a simplified graphical user interface (GUI) remote from a COTS cost software management program, and not require multiple manual entry of the same resource planning data into other systems.

### SUMMARY OF THE INVENTION

By this invention there is provided an improved network integrated method and system for resource planning and management.

In one embodiment, the present invention comprises in general the following: a cost management software program which has a plurality of interfaces; a first graphical user interface (GUI); a second graphical user interface (GUI); a computer network linking the cost management software program, the first GUI and the second GUI; and a data processing software program. The first graphical user interface (GUI) is adapted for use by sophisticated users of the cost management software program and the second GUI is adapted for use by unsophisticated users of the cost management software program. The data processing software program has a first aspect for extracting a raw first data set from the second GUI and subsequently processing the raw first data set resulting in a processed first data set. In one embodiment, the processed first data set may then be “imported” into the cost management software program. The data processing software program also has a second aspect for processing a raw second data set resulting in a processed second data set and subsequently at least partially populating the second GUI with the processed second data set.

### BRIEF DESCRIPTION OF THE DRAWINGS

The objects, advantages and features of this invention will become more apparent from a consideration of the following detailed description and the drawings, in which:

FIG. 1 is a simplified block diagram of one embodiment of the present invention.

FIG. 2 is a screen shot of one embodiment of the first GUI.

FIG. 3 is a simplified block diagram of one embodiment of the second GUI and data processing software program.

FIG. 4 is a simplified block diagram of another embodiment of the second GUI and data processing software program.

FIG. 5 is a screen shot of a first portion of one embodiment of the second GUI.

FIG. 6 is a screen shot of a second portion of one embodiment of the second GUI.

FIG. 7 is an illustrative diagram of one portion of another embodiment of the second GUI.

FIG. 8 is an illustrative diagram of another portion of another embodiment of the second GUI.

FIG. 9 is flow chart of one aspect of one embodiment of the data processing software program.

FIG. 10 is a flow chart of another aspect of one embodiment of the data processing software program.

FIG. 11 is a screen shot of one embodiment of the data processing software program.

### DETAILED DESCRIPTION

By this invention there is provided an improved method and system for resource planning and management. In the following description, reference is made to accompanying FIGURES. which form a part hereof, and which are shown, by way of illustration, several embodiments of the present invention. It is understood that other embodiments may be utilized and structural changes may be made without departing from the scope of the present invention.

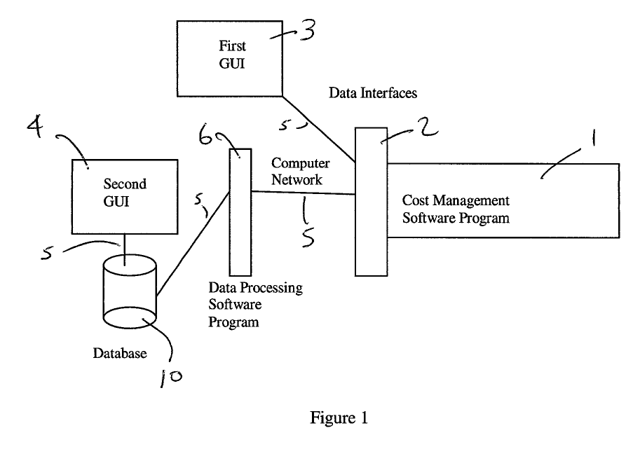

FIG. 1 is a simplified block diagram of one embodiment of the present invention, comprising in general the following: a cost management software program 1 which has a plurality of interfaces 2; a first graphical user interface (GUI) 3; a second graphical user interface (GUI) 4 which has a database 10; a computer network 5 linking the cost management software program 1, the first GUI 3 and the second GUI 4; and a data processing software program 6. In one embodiment, the computer network 5 is a local area network (LAN), and the like. In another embodiment, the computer network 5 is the internet. In yet another embodiment, the computer network 5 is a wireless network. In still yet another embodiment, the computer network 5 is a wide area network (WAN), and the like.

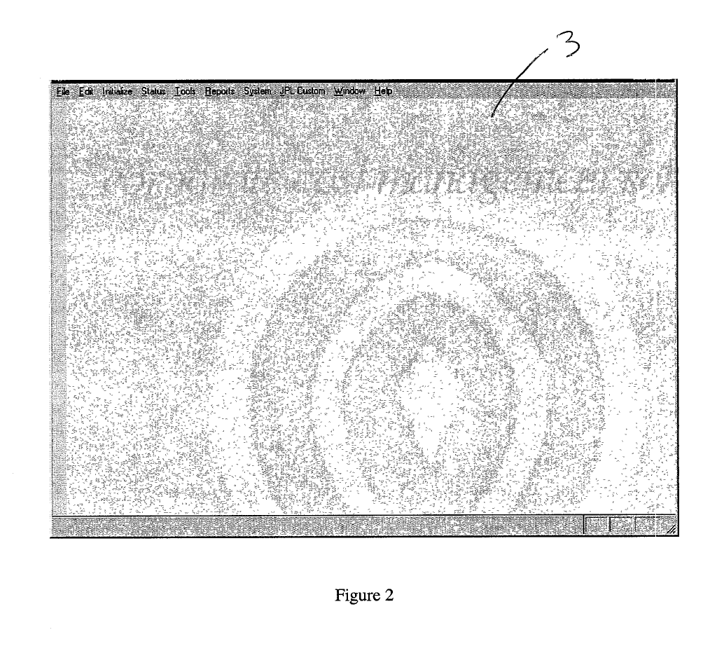

As illustrated in FIG. 2, one embodiment of the first GUI 3 is adapted for use by sophisticated users of the cost management software program 1. Also as illustrated in FIG. 2, the first GUI 3 is associated with a commercial, off-the-shelf (COTS) cost management software program 1 such as Cobra by Welcom, Microframe Program Manager, Artemis, aid the like. In one embodiment, the cost management software program 1 resides on a personal computer. In another embodiment, the cost management software program 1 resides on a server. Also in one embodiment, the cost management software program 1 has the capability to import and export data from its plurality of interfaces 2 according to pre-defined interfaces and structures.

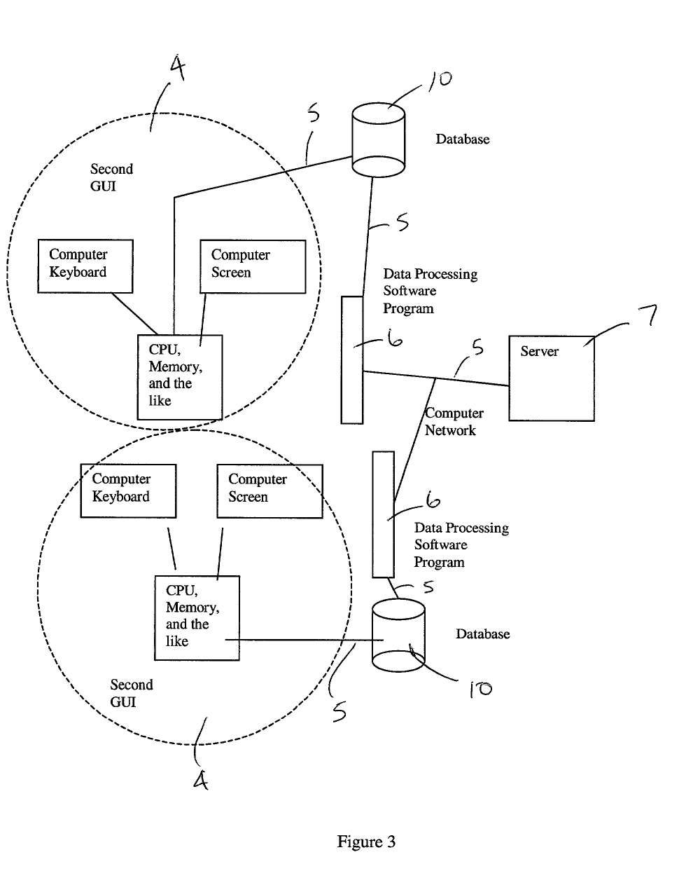

FIG. 3 is a simplified block diagram of one embodiment of the second GUI 4, database 10, and data processing software program 6. The second GUI 4 is adapted for use by unsophisticated users of the cost management software program 1. As illustrated in FIG. 3, the second GUI 4 includes a plurality of second GUIs 4, along with a plurality of data processing software programs 6 and databases 10 linked to a server 7 via a computer network 5.

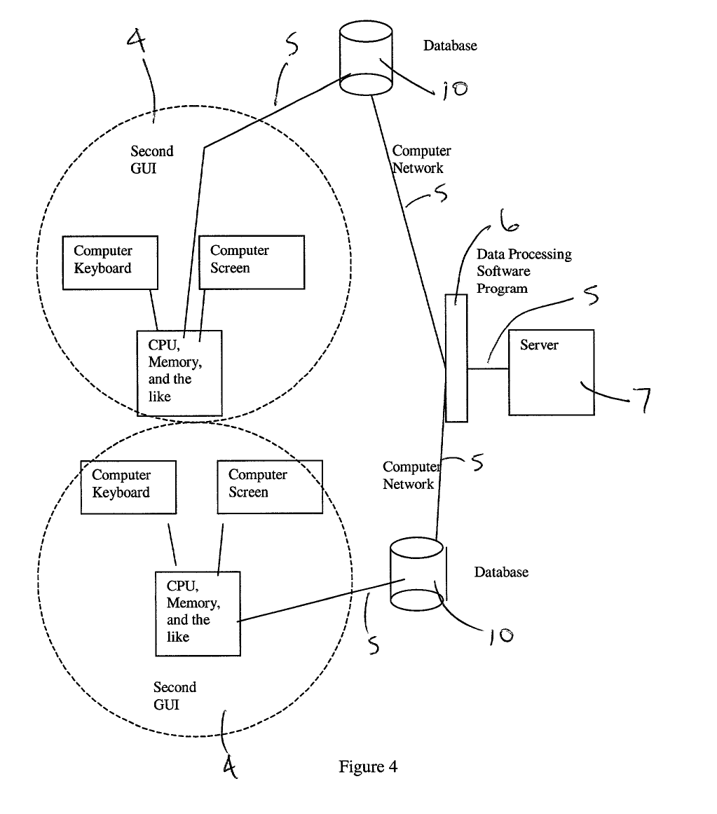

FIG. 4 is a simplified block diagram of another embodiment of the second GUI 4, database 10, and data processing software program 6. As illustrated in FIG. 4, the second GUI 4 includes a plurality of second GUIs 4 and databases 10 linked to a server 7 via a computer network 5. As further illustrated in FIG. 4, the data processing software program 6 resides on the server 7.

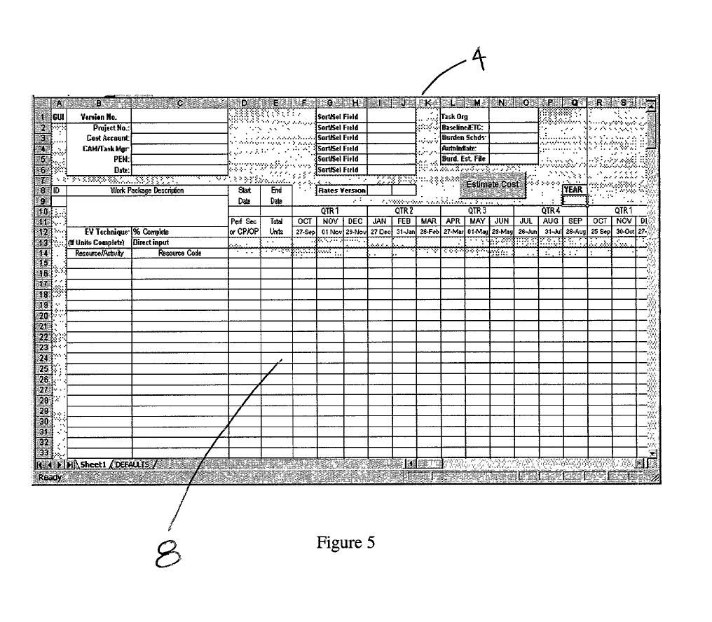

FIG. 5 is a screen shot of a first portion 8 of one embodiment of the second GUI 4. In one embodiment, as further illustrated in FIG. 5, the second GUI 4 is a formatted spreadsheet such as Microsoft Excel, and the like, and is configured so that an unsophisticated user may enter into it resource planning data, which then may be saved into a database 10. In one embodiment, the second GUI 4 also operates on one or more personal computer operating systems.

In one embodiment, as further illustrated in FIG. 5, the first portion 8 of the preformatted spreadsheet contains resource planning time phasing information, such as planning interval start dates and multiple planning intervals including months, years, and the like. Also in one embodiment, the first portion 8 of the second GUI 4 contains one or more pull-down menus or “pick lists” which contain, among other things, resource code information relating resources selected to a cost management software program, persons responsible for the resource planning information, burdening scheme to apply to plan inputs, type of plan such as baseline or estimate to complete, cost account sort/select codes, type of earned value technique to apply to work packages, whether or not to account for inflation, and the like. In one embodiment as further illustrated in FIG. 5, the first portion 8 of the second GUI 4 further contains “pick list” information for one or more types of resource plan categories, such as labor, services, travel, subcontracts, procurements, and the like. In one embodiment as further illustrated in FIG. 5, the first portion 8 of the second GUI 4 has certain pre-defined fields to contain other information such as responsible organization and program numbers, memo fields, dates of information input, cost account and work package identifiers, work package name, and work package start and end dates. Also in one embodiment, the first portion 8 of the second GUI 4 accepts data entry information for multiple work packages within a single cost account which may be differently time phased from each other. Further in one embodiment, the first portion 8 of the second GUI 4 supports earned value management planning, and contains data fields which are adapted to identifying planned personnel by “home” organization, so as to enable workforce forecasting by such organization. Still further in one embodiment, at least one aspect of the data processing software program 6 may be accessed by the user from the first portion 8 of the second GUI 4 in the form of a “soft” button.

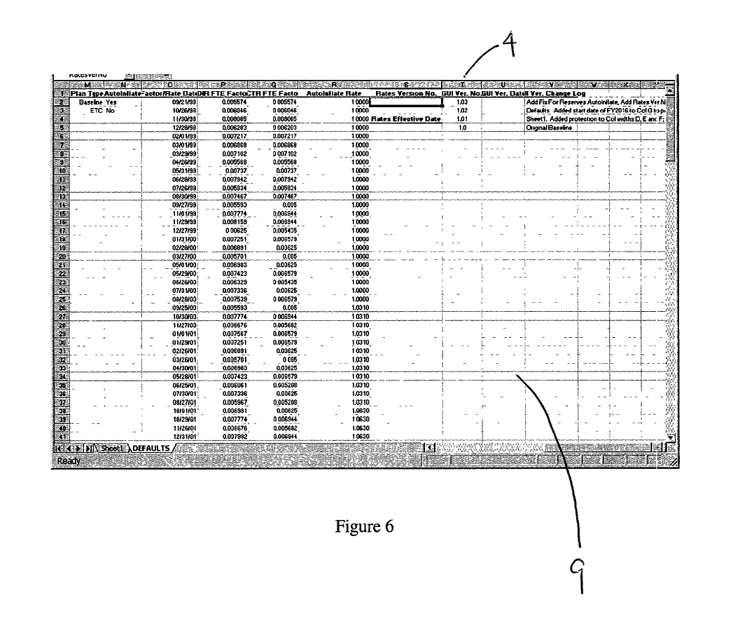

FIG. 6 is a screen shot of a second portion 9 of one embodiment of the second GUI 4. As illustrated in FIG. 6, in one embodiment, the second GUI 4 has at least a second portion 9 which contains certain information, some of which is linked to the first portion 8 of the second GUI 4, where such certain information appears to the unsophisticated user in the form of “pick lists.”

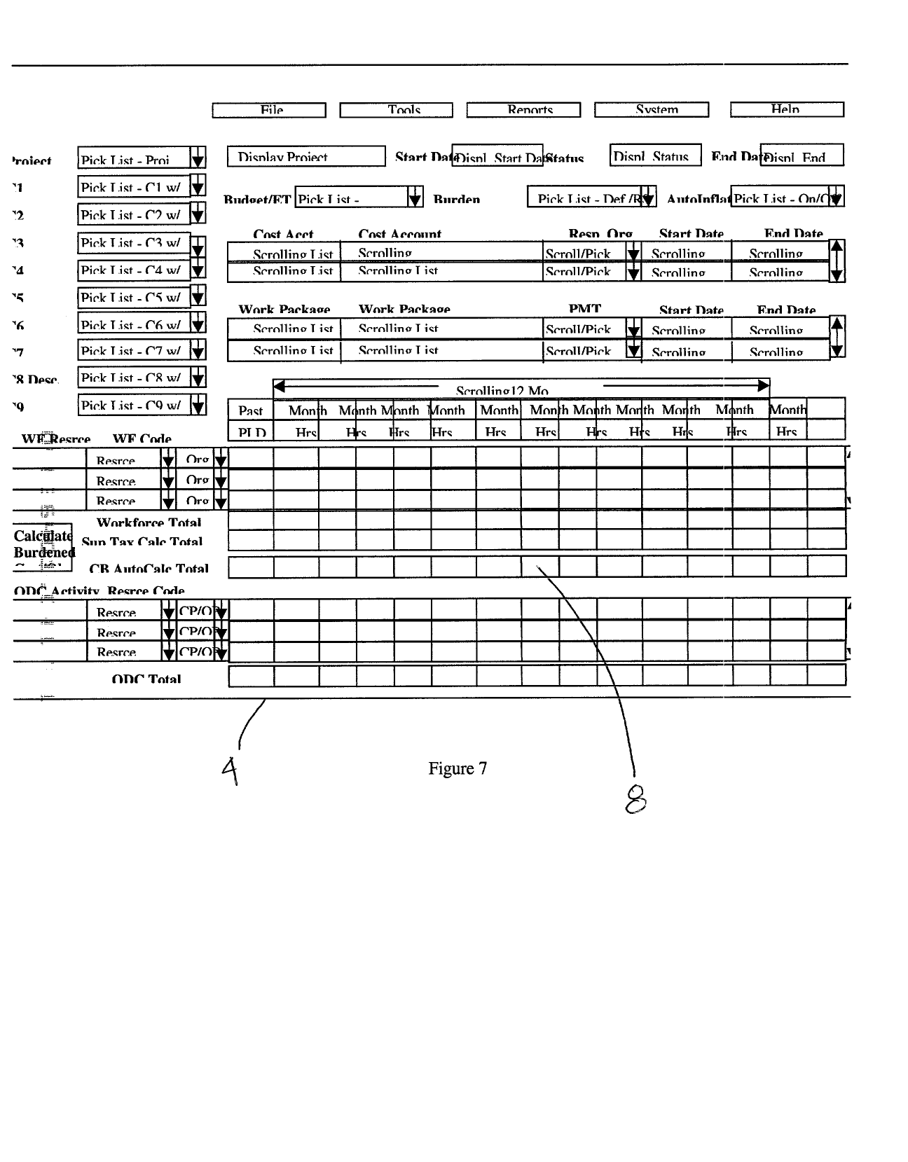

FIG. 7 is an illustrative diagram of a first portion 8 of another embodiment of the second GUI 4. In one embodiment, as further illustrated in FIG. 7, the second GUI 4 is adapted so as to be utilized and accessed via a web browser, and is configured so that an unsophisticated user may enter into it resource planning data, which then may be saved into a database 10. In one embodiment, the second GUI 4 also operates on one or more personal computer operating systems. In one embodiment, certain database 10 data is obtained from the cost management software program 1.

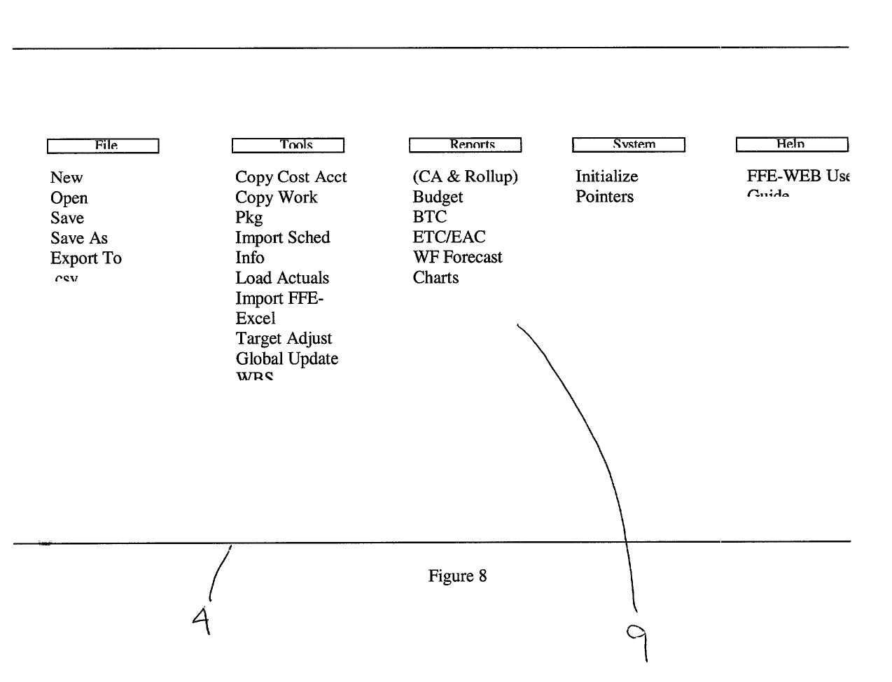

FIG. 8 is an illustrative diagram of a second portion 9 of another embodiment of the second GUI 4. As illustrated in FIG. 8, in one embodiment, the second GUI 4 has at least a second portion 9 which contains user menus adapted to accessing the data processing software program 6 and performing other data processing steps.

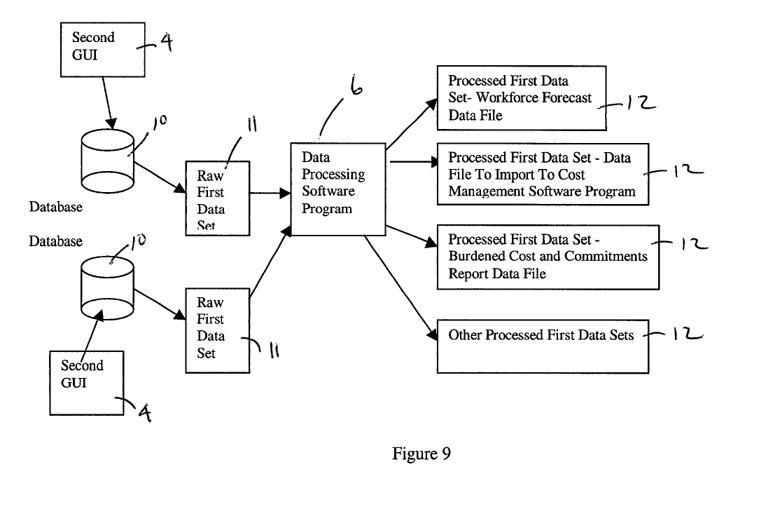

FIG. 9 is a flow chart of one aspect of one embodiment of the data processing software program 6. As further illustrated in FIG. 9, one or more raw first data sets 11 are extracted from one or more databases 10 and are then processed by the data processing software program 6. Shown resulting from the data processing software program 6 are several of the many possible processed first data sets 12. In one possible instance, the processed first data set 12 results in a workforce forecast data file. In a second possible instance, the processed first data set 12 results in a data file which is adapted to be imported into the cost management software program 1. In a third possible instance, the processed first data set 12 results in a burdened cost and commitments report data file. As illustrated further in FIG. 9, many other results are possible from the processed first data set 12.

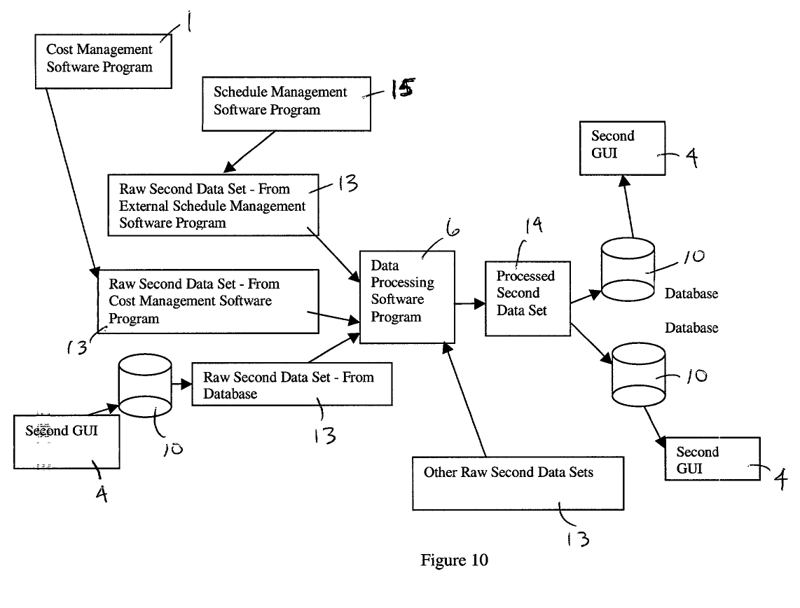

FIG. 10 is a flow chart of another aspect of one embodiment of the data processing software program 6. As further illustrated in FIG. 10, one of several possible raw second data sets 13 is processed by the data processing software program 6, resulting in a processed second data set 14. The processed second data set 14 flows into one or more databases 10, which is then viewable on one or more second GUIs 4. In one possible instance, the raw second data set 13 is from an external schedule management software program 15. In another possible instance, the raw second data set 13 is from the cost management software program 1. In yet another possible instance, the raw second data set 13 is from a database 10 which has been populated by a second GUI 4. As illustrated further in FIG. 10, other raw second data sets 13 are available for processing by the data processing software program 6 from other sources not specifically defined.

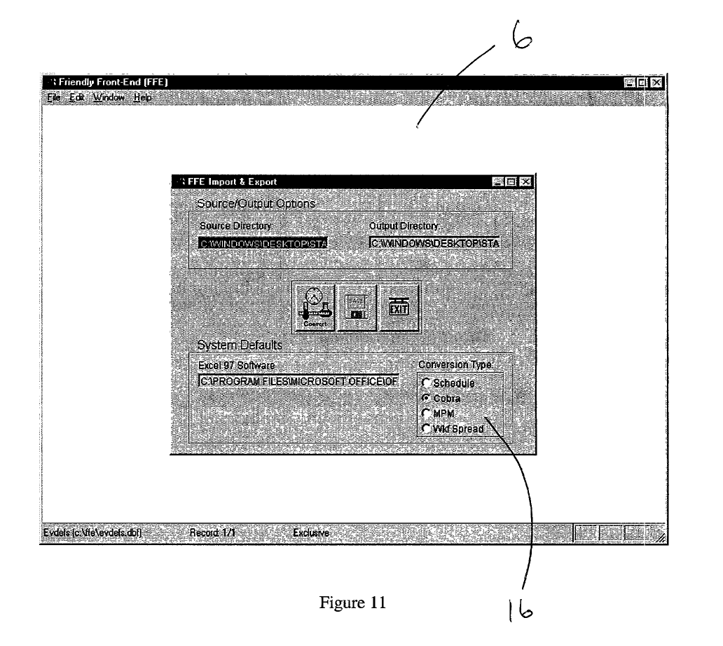

FIG. 11 is an illustrative screen shot of one embodiment of the data processing software program 6. As illustrated in FIG. 11, in one embodiment, the data processing software program 6 has a configurable menu interface 16 which permits a user to and setup its computer operating environment and select various data processing software program 6 aspects and instances. As further illustrated in FIG. 11, a user may determine data processing software program 6 options, including a processed first data set 12 which is selectably adapted for import into different cost management software programs 1, such as Cobra by Welcom, Microframe Program Manager, Artemis, and the like.

I claim:

1. A network integrated system for resource planning and management comprising:
a cost management software program, the cost management software program having a plurality of interfaces;
a first graphical user interface (GUI), the first GUI being for sophisticated users of the cost management software program;
a second GUI, the second GUI being for unsophisticated users of the cost management software program;
a database, the database being for storing data for the second GUI;
a computer network; and
a data processing software program, the data processing software program having a first aspect, the first aspect being for extracting a raw first data set from the database and subsequently processing the raw first data set resulting in a processed first data set, and the data processing software program having a second aspect, the second aspect being for processing a raw second data set resulting in a processed second data set and subsequently at least partially populating the database with the processed second data set, wherein the cost management software program, the first GUI, the second GUI, and the database are linked via the computer network.

2. A system as claimed in claim 1, wherein the raw second data set contains data extracted from a schedule management software program.

3. A system as claimed in claim 1, wherein the raw second data set contains data extracted from the cost management software program.

4. A system as claimed in claim 1, wherein the second GUI is a plurality of second GUIs.

5. A system as claimed in claim 1, wherein the database is a plurality of databases.

6. A system as claimed in claim 4, wherein a plurality of unsophisticated users of the cost management software program may employ the plurality of second GUIs simultaneously.

7. A system as claimed in claim 1, wherein the raw first data set contains time-phased resource planning data.

8. A system as claimed in claim 7, wherein the processed first data set is a data file adapted for interfacing with the cost management program.

9. A system as claimed in claim 7, wherein the processed first data set is a data file containing burdened costs and commitments.

10. A system as claimed in claim 7, wherein the processed first data set is a data file containing a workforce forecast.

11. A system as claimed in claim 1, wherein the second GUI is a formatted spreadsheet.

12. A system as claimed in claim 1, wherein the second GUI is adapted to be accessed via a web browser software program.

13. A system as claimed in claim 1, wherein the data processing software program has a third aspect, the third aspect being for overwriting specified information stored in the database with uniform values.

14. A network integrated method for resource planning and management, comprising the steps of:
entering a raw first data set into a first graphical user interface (GUI) to a cost management software program, the raw first data set containing sophisticated data, the first GUI being for sophisticated users, the cost management software program being in a first location;
processing the raw first data set into a processed first data set;
entering a raw second data set into the second GUI to the cost management software program, the raw second data set containing unsophisticated data, the second GUI being for unsophisticated users, the second GUI being in a second location;
storing the raw second data set into the database;
extracting the raw second data set from the database;
processing the raw second data set into a processed second data set;
transferring the processed second data set from the second location to the first location via a computer network;
importing the processed second data set into the cost management software program; and
validating the processed second data set against the processed first data set.

15. A method as claimed in claim 14, further comprising the step of:
at least partially populating the second GUI with data from the processed first data set prior to the entering the raw second data set into the second GUI step.

16. A method as claimed in claim 14, further comprising the step of:
at least partially populating the second GUI with data from a processed third data set prior to the entering the raw second data set into the second GUI step.

17. A method as claimed in claim 14, wherein the entering the raw second data set into a second GUI step comprises entering a plurality of raw second data sets into a plurality of second GUIs.

18. A network integrated system for resource planning and management comprising:
a cost management software program, the cost management software program having a plurality of interfaces;
a first graphical user interface (GUI), the first GUI being for sophisticated users of the cost management software program;
a second GUI, the second GUI being adapted for use via a web browser, the second GUI being also for unsophisticated users of the cost management software program;
a computer network; and
a data processing software program, the data processing software program having a first aspect, the first aspect being for extracting a raw first data set from the second GUI and subsequently processing the raw first data set resulting in a processed first data set, and the data processing software program having a second aspect, the second aspect being for processing a raw second data set resulting in a processed second data set and subsequently at least partially populating the second GUI with the processed second data set, wherein the cost management software program, the first GUI, and the second GUI are linked via the computer network.
